(19) United States
(12) Patent Application Publication
(10) Pub. No.: US 2010/0113117 A1
(43) Pub. Date: May 6, 2010

(54) METHOD FOR DANCE GAME AND THE RECORDING MEDIA THEREIN READABLE BY COMPUTER

(75) Inventors: Andrew Ku, Seoul (KR); Taehoon Kim, Seoul (KR); Do Hoon Kim, Seoul (KR); Jong Sook Kim, Seoul (KR); KeeSeok Jeong, Gyeonggi-do (KR); Hui Jeong Hong, Gyeonggi-do (KR)

Correspondence Address: FISH & RICHARDSON P.C., P.O. BOX 1022, MINNEAPOLIS, MN, 55440-1022, US

(73) Assignee: Nurien Software, Seoul (KR)

(21) Appl. No.: 12/595,791

(22) PCT Filed: Apr. 14, 2008
(86) PCT No.: PCT/KR2008/002084

§ 371 Date: Oct. 28, 2009

(30) Foreign Application Priority Data
Apr. 12, 2007 (KR) 1020070036050

(51) Int. Cl. A63F 9/24; A63F 13/00

(52) U.S. Cl. 463/7; 463/32

(57) ABSTRACT

A dance game method and computer-readable storage medium storing instructions for implementing the dance game method is provided. The dance game method arouses a user's interest to feel a sensation of being assimilated with a virtual character dancing according to music.

### TECHNICAL FIELD

The present invention relates to a dance game method and computer-readable storage medium storing the dance game method, and more particularly, to a dance game method and computer-readable storage medium storing the dance game method that can arouse a user's interest to feel a sensation of being assimilated with a virtual character on an online game dancing according to music.

### BACKGROUND ART

A pump game, the original dance game, is a game where a user touches corresponding stepping pads with feet according to displayed direction indicators such as ‘→’, ‘←’, ‘↑’, ‘↓’, [symbol] , and [symbol] , and scores a result of the user's touching, accordingly, the user becomes a dancer through the pump game and may have an exercise effect while enjoying the game. However, the pump game generally has many limits in view of time and space since the stepping pads, a display interface, and a main body of the pump game are quite large. Further to this, a gamer user's need to enjoy a dance game itself is not satisfied in contrast to a general computer game.

The above described limits have been solved by installing the function of the pump game in a desktop or a portable terminal and embodying a user interface via an input interface such as a keyboard instead of the stepping pads, thereby the game user may enjoy the game anytime and anywhere.

However, a conventional dance game is monotonous since a user presses predetermined keys according to rhythms of music of the dance game, accordingly, there is a limit in arousing a user's interest.

### DISCLOSURE OF INVENTION

### Technical Goals

The present invention provides a dance game method and computer-readable storage medium storing the dance game method that can induce an effect of being a virtual character dancing and induce a user's interest to be the virtual character on an online game since various graphic elements (hereinafter “rhythm notes”) are displayed to induce the user to press a key at a location corresponding to a dance motion of the virtual character, and the user presses the corresponding key according to the rhythm note.

### Technical Solutions

According to an aspect of the present invention, there is provided a dance game method of a dance game apparatus including a dance animation storage unit storing motion information of a virtual character, a rhythm note information storage unit storing rhythm note information that displays various types of rhythm notes, which are graphic elements to induce a user's key press at a corresponding location to a specific motion of the virtual character, and a dance game control unit controlling an image processor that processes the motion information and the rhythm notes and outputs the processed motion information and rhythm notes to a display interface, the method including steps of (a), (b), (c), and (d) performed in the dance game control unit: (a) controlling the image processor to display the motion information, searching each frame of the motion information, and determining whether the virtual character is in a predetermined specific motion state; (b) controlling the image processor to display the rhythm note on predetermined coordinates according to a dance motion of the virtual character when the virtual character is in the predetermined specific motion state as a result of the determination; (c) verifying whether a corresponding key to the rhythm note being displayed through the step of (b) is inputted; and (d) counting a score indicating the user's game ability when the corresponding key is inputted as a result of the verification in the step of (c).

In the above described steps, the rhythm note being displayed through the step of (b) may be a type of a moving picture which is sequentially transformed to disappear based on the predetermined coordinates.

Also, the rhythm note being displayed through the step of (b) may explode when disappeared.

The motion information being displayed in the step of (a) may be produced via a three-dimensional graphic tool, and the rhythm note being displayed through the step of (b) is based on three dimensional coordinates.

The rhythm note being displayed through the step of (b) may be a direction note which is displayed according to a moving direction of a specific portion of the virtual character, or a ring note encircling the virtual character.

When the rhythm note being displayed through the step of (b) is the direction note, the step of (c) may verify whether the corresponding key to the rhythm note is inputted at a predetermined key input point.

When the rhythm note being displayed through the step of (b) is the ring note, the step of (c) may verify whether the corresponding to the rhythm note is continuously inputted for a predetermined key press time.

Also, the dance game method further may include: (e) counting a point to upgrade motions of the virtual character when the corresponding key to the rhythm note is inputted as a result of the verification in the step of (c); and (f) controlling the image processor to upgrade the dance motion of the virtual character and display the upgraded dance motion when there is a key input using the point.

The step of (f) may display a previous motion with a present motion of the virtual character.

The present invention may provide a computer-readable storage medium storing the dance game method.

### BRIEF DESCRIPTION OF DRAWINGS

FIG. 1 is a block-diagram illustrating a dance game apparatus according to an embodiment of the present invention;

FIGS. 2 and 3 are flowchart illustrating a dance game method according to an embodiment of the present invention; and

FIGS. 4 through 13 are diagrams illustrating displays of a dance game apparatus according to an embodiment of the present invention.

### BEST MODE FOR CARRYING OUT THE INVENTION

Hereinafter, a dance game method will be described in detail by referring to accompanied drawings according to exemplary embodiments of the present invention.

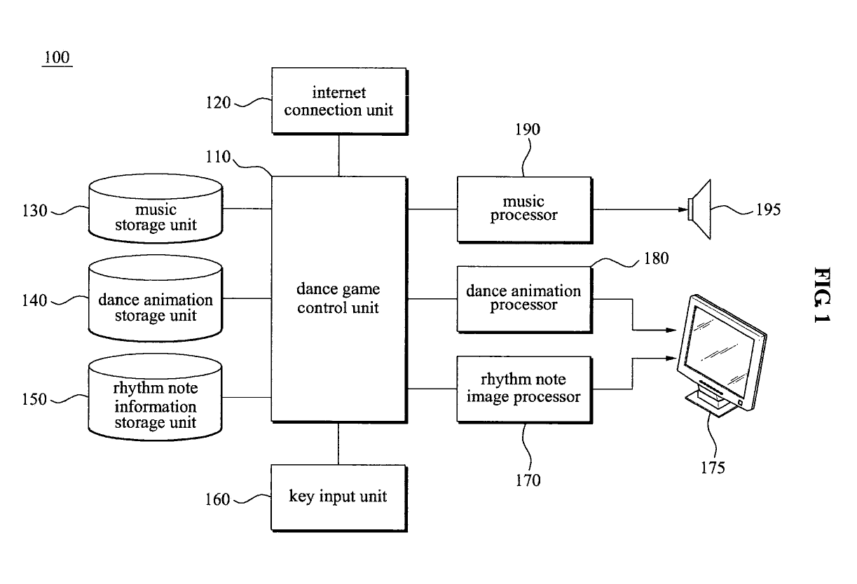

FIG. 1 is a block-diagram illustrating a dance game apparatus 100 according to an embodiment of the present invention.

As illustrated in FIG. 1, the dance game apparatus 100 according to the present invention includes a music storage unit 130 storing music information having formats of mp3, way, and the like, a music processor 190 processing the music information stored in the music storage unit 130 to output the processed music information via a speaker 195, a dance animation storage unit 140 storing characters performing predetermined dance motions according to the outputted music and background image data, a dance animation processor 180 performing a motion-picture process with respect to the animation stored in the dance animation storage unit 140 to output the processed animation to a display interface 175, a rhythm note information storage unit 150 storing information that displays a rhythm note at a corresponding location according to a specific motion of the character, a rhythm note image processor 170 generating a rhythm note based on the information stored in the rhythm note information storage unit 150 and performing an image-process with respect to the generated rhythm note to output the image-processed rhythm note, a key input unit 160 allowing a user to input a key according to the rhythm note displayed on the display interface 175, an Internet connection unit 120 functioning to connect to an Internet so that the user can enjoy a dance game with other game users, and a dance game control unit 110 controlling the aforementioned units to perform the dance game.

In the above described configuration, the dance motion information stored in the dance animation storage unit 140 may be three-dimensional (3D) animation, and may be produced via a general three-dimensional graphic tool such as a 3D Max. Information indicating a motion state of the character, a base of displaying the rhythm note, in the dance animation storage unit 140.

The rhythm note information stored in the rhythm note information storage unit 150 is produced via a method of generating a 3D object at a predetermined location according to motions of the character and rhythm. In this instance, the predetermined location is determined based on a location value of a character in consideration of a moving line of the character, a dance motion of the character, rhythms of music, and locations of protrusion portions of the character such as feet, hands, a head, heels, and the like. Therefore, each rhythm note information includes information about a displayed shape of a rhythm note, 3D coordinates of a displayed location of the rhythm note, a key input value of the rhythm note, a key input point, or a key press time. Also, the rhythm note is produced according to dance motions of a character or an intention of a producer, and a parameter may be included in the rhythm note information. Detailed example of the rhythm note information will be described later in a dance game method of the present invention.

Specifically, the dance game control unit 110 synchronizes the music processor 190 and the dance animation processor 180 to adjust dance motions of a character to the outputted music. That is, by synchronizing music data and game event data, the music processor 190 and the dance animation processor 180 are controlled so that motions of a character may be adjusted to a changed music tempo even when a music tempo is changed.

The dance game control unit 110 controls the rhythm note image processor 170 and the dance animation processor 180 based on the rhythm note information stored in the rhythm note storage unit 150. The dance game control unit 110 controls the rhythm note image processor 170 to display rhythm note according to a changed music tempo when the motions of the character are changed according to changes of music tempo. Also, the dance game control unit 110 verifies whether a user presses a corresponding key to the rhythm note information stored in the rhythm note information storage unit 150 or a user presses a key at an accurate key press time when the rhythm note is displayed, and scores a game ability according to a result of the verification. Further to this, the dance game control unit 110 performs various functions to arouse a user's interest, which will be described later by referring to the dance game method of the present invention.

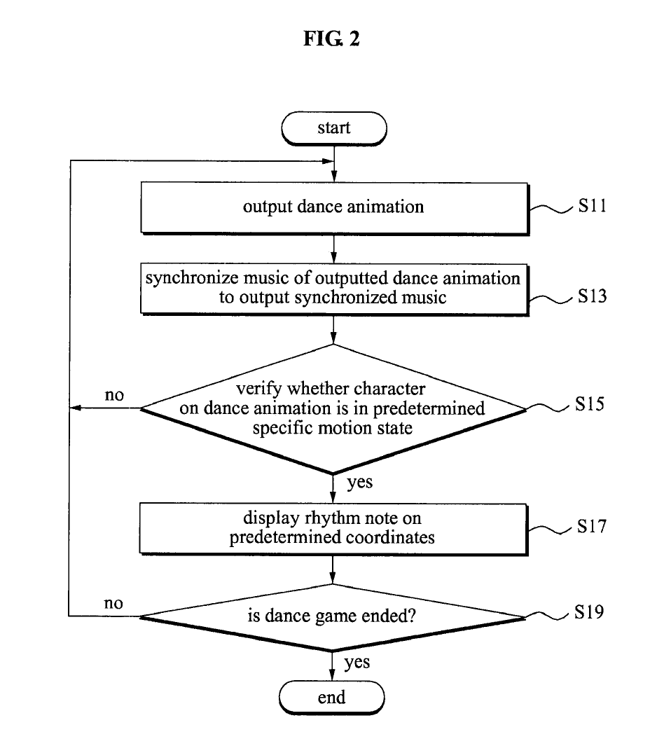

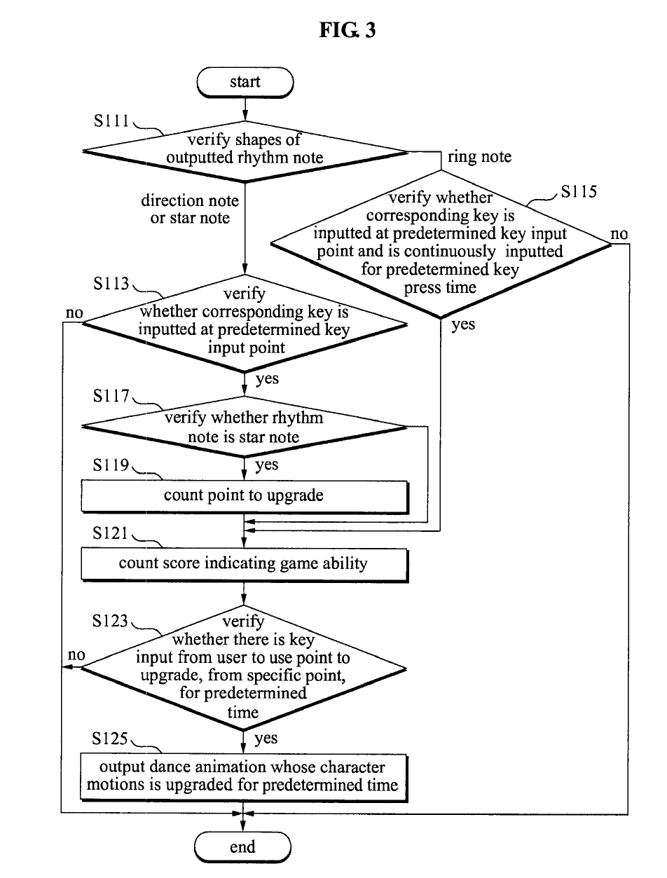

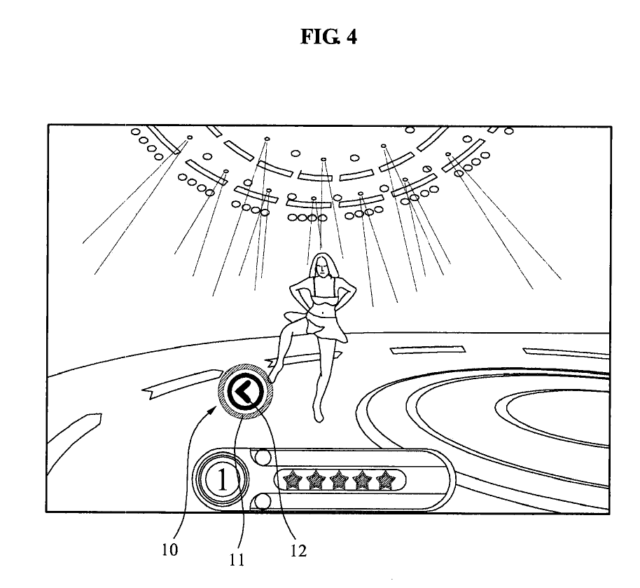

FIG. 2 is a flowchart illustrating operations of outputting a rhythm note image according to a dance game method of the present invention, FIG. 3 is a flowchart illustrating operations of performing a dance game according to a user's key input in a dance game method of the present invention, and FIGS. 4 through 13 are diagrams illustrating displays of games on a dance game apparatus according to the present invention. In this instance, subjects of FIGS. 2 and 3 are the dance game control unit 110 of FIG. 1.

As illustrated in FIG. 2, the dance game control unit 110 of FIG. 1 controls the dance animation processor 180 of FIG. 1 to output dance animation in operation S11, and music of the dance animation is synchronized to output synchronized music in operation S13.

In operation S15, each frame of the dance animation is searched, and whether a character on the dance animation is in a predetermined specific motion state is verified based on specific motion information of the character stored in the dance animation storage unit 140 of FIG. 1.

As a result of the verification in operation S15, when the character is not in the predetermined specific motion state, the dance game control unit 110 of FIG. 1 returns to operation S11. Conversely, when the character is in the predetermined specific motion state, the dance game control unit 110 proceeds to operation S17, and controls the rhythm note image processor 170 of FIG. 1 to display a rhythm note on predetermined coordinates on the dance animation based on the rhythm note information.

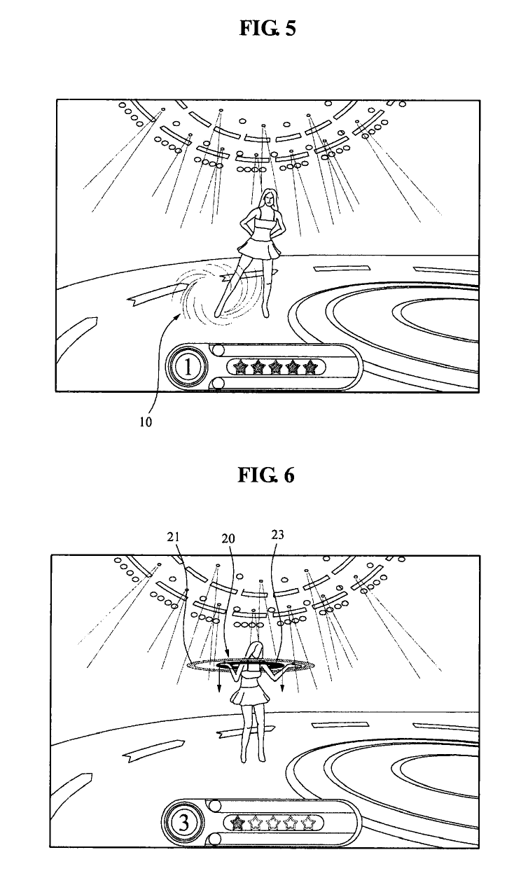

Shapes of the rhythm note are variously produced according to dance motions of the character or an intention of a producer. As an example, a direction note 10 may be in a shape of ‘<’ according to movements of a right foot of the character as illustrated in FIGS. 4 and 5. In this instance, the direction note 10 is displayed according to moving directions of hands or feet of the character, and the shapes of the rhythm note may correspond to direction indicators such as ‘>’, [symbol] and the like. Also, the shapes of the rhythm note may be a ring note 20 according to wave motions of the character as illustrated in FIGS. 6, 7, and 8.

Also, the rhythm note may desirably produce a moving picture which is sequentially transformed to disappear to inform a user about a key input point or a key press time based on the predetermined coordinates.

The dance game control unit 110 controls the rhythm note image processor 170 based on the rhythm note information so that a ring 11 of the direction note 10 is tightened toward a center as illustrated in FIG. 4, the rhythm note explodes when the direction note 10 reaches a direction indicator 12 as illustrated in FIG. 5. When the rhythm note explodes, rotation angle information indicating a rotation direction of the explosion figure is included in the rhythm note information as illustrated in FIGS. 5, 8, 9, and 10. A point when an outside of the ring 11 reaches the direction indicator 12 is the key input point.

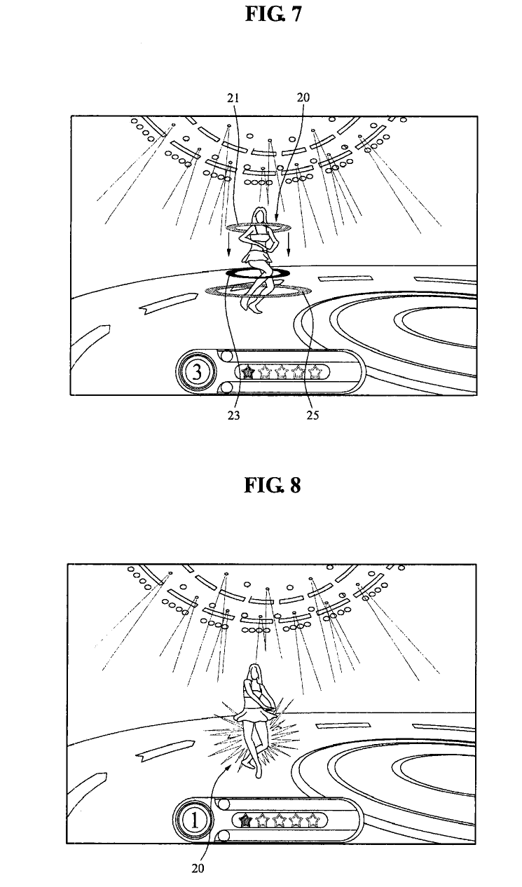

In producing the ring note 20, the dance game control unit 110 controls the rhythm note image processor 170 so that a new moving ring 23 appears from an upper ring 21, and the moving ring 23 is tightened toward a center to reach the character as illustrated in FIG. 6, moves to a downward as illustrated in FIG. 7, and explodes when reaching a down ring 25 as illustrated in FIG. 8. In this instance, a point when the moving ring 23 is tightened toward a center to reach the character is a key input point, and a point when the moving ring 23 moves to the downward is a key press point.

The rhythm note may not be limited to the above described examples may be variously modified within the scope of the claims of the present invention. As an example, the direction indicator may be embodied in any shapes that can be recognized by the user, and the key input point and the key press point may be conveyed to the user by changing colors of the rhythm note. Also, the rhythm note may be a still picture, and the direction note 10 may be displayed on body portions of the character such as hands, feet, a head, heels, knees, and the like. Consequently, a user may feel a sensation of being assimilated with a dancing character by manipulating a key according to music via images of the rhythm note.

In operation S19, the dance game control unit 110 verifies whether the dance game is ended, that is a key signal to end the dance game is inputted from the user, and returns to operation S11 when the dance game is not ended as a result of the verification.

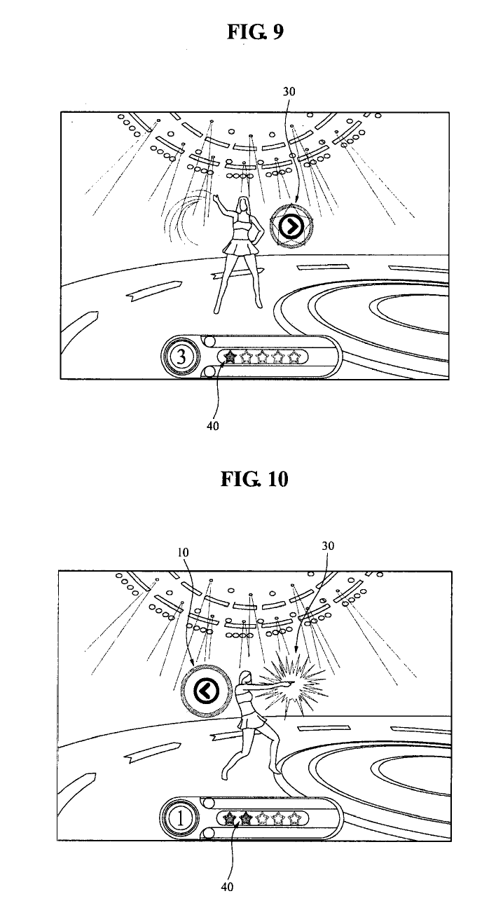

Additionally, as illustrated in FIG. 3, by verifying shapes of the rhythm note outputted in operation S111, when the outputted rhythm note corresponds to a star note 30 or the direction note 10 as a result of the verification, the dance game control unit 110 performs operation S113. In this instance, the star note 30 is a changed note of the direction note 10, and is displayed according to moving directions of the hands or legs of the character, similar to the direction note 10. The star note 30 is encircling the direction note 10 as illustrated in FIG. 9. In operation S113, whether a corresponding key is accurately inputted verified at a predetermined key input point, when the key input is accurate as a result of the verification, the dance game control unit performs operation S117, and verifies whether the rhythm note corresponds to the star note 30. When the rhythm note corresponds to the star note 30 as a result of the verification in operation S117, the dance game control unit 110 performs operation S119 and S121, and counts a point to upgrade motions of the character in operation S119 and counts a score indicating a game ability in operation S121. As illustrated in FIGS. 9 and 10, when user inputs a key corresponding to ‘>’ at an accurate key input point, an upgrade point 40 is counted, and a result of the upgrade is displayed. Conversely, when the rhythm note is the direction note 10 as a result of the verification in S117, the dance game control unit 110 exclusively performs operation S119 without performing operation S117.

As a result of the verification in S111, when the rhythm note is a ring note 20, operation S115 is performed. In operation S115, whether a corresponding key to the ring note 20 is accurately inputted at the predetermined key input point and is continuously inputted for a predetermined key press time is verified. When the key is accurately inputted as a result of the verification in S115, operation S121 is performed.

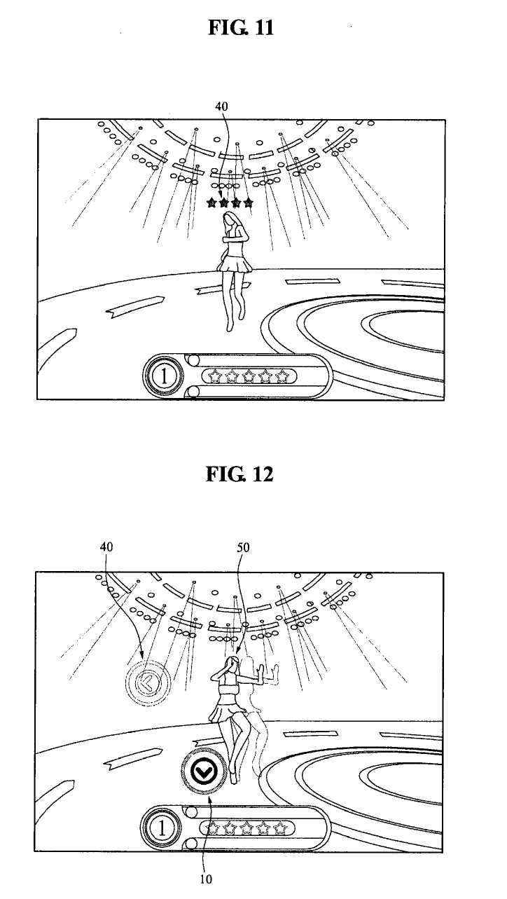

In operation S123, whether there is a key input to use the point to upgrade is verified. When a key to use the point to upgrade such as ‘enter’ is inputted as a result of the verification in S123, operation S125 is performed, and the dance animation control unit 110 controls the dance animation processor 180 to output dance animation whose character motion is upgraded for a predetermined time. As an example, as illustrated in FIGS. 11 through 13, the dance game control unit 110 may control the dance animation processor 180 to display a previously used point on the character, and an incidental image of a previous motion of the character is formed on a present motion. Therefore, the user may enjoy a dance game more excitingly by using the point to upgrade.

Also, the dance game apparatus 100 is embodied in portable terminals such as a portable multimedia player (PMP), a notebook, a desktop, and the like, and specifically the Internet connection unit 120 functions to connect to a local area network (LAN) or a broadband communication network via a wired/wireless communication and is connected to a dance game management server which can be used by a plurality of users. Accordingly, the user may use the dance game on a virtual space with other users.

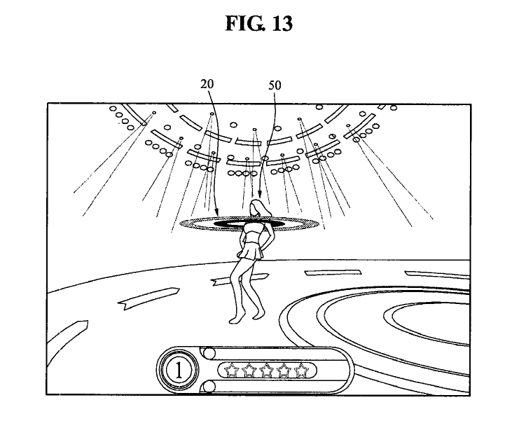

As an example of the online dance game, the above described dance game managing server checks obtained scores or upgrade points of each of users in real time, each of the users enjoying an identical game on a virtual space. During the operation of the checking, by assigning the above described function in operation S125 to a user who has obtained highest scores or highest upgrade points or to a user who has requested to use upgrade points, a character of the user who has obtained highest scores or highest upgrade points is distinguished from other characters as illustrated in FIG. 13. For this, the game management server provides the dance game apparatus 100 with information about dance animation including other users' character images, music, and rhythm notes in real time, accordingly the dance game control unit 110 performs an online game based on the information transmitted from the dance game management server.

The dance game method and a computer-readable storage medium storing the dance game method is not limited to the above described embodiments and may be variously modified within a scope of ideas of the present invention. As an example, the dance game apparatus of the present invention may include a tool manually producing rhythm note information according to a motion of a character, accordingly a dance game control unit may perform a dance game based on the rhythm note information produced in the rhythm note producing tool. Also, the dance game method according to the present invention may be used in video game devices such as the Arcade Game devices, Play Station (PS) of SONY, Xbox of Microsoft Inc., and the like.

The dance game method according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, it is possible to induce an effect of a user being a virtual character dancing and arouse a user's interest to be the virtual character on an online game since various graphic elements, that is rhythm notes, are displayed to induce the user to press a key at a location corresponding to a dance motion of the virtual character, and the user presses the corresponding key according to the rhythm note.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. Therefore, it is intended that the scope of the invention be defined by the claims appended thereto and their equivalents. Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A dance game method of a dance game apparatus including a dance animation storage unit storing motion information of a virtual character, a rhythm note information storage unit storing rhythm note information that displays various types of rhythm notes, which are graphic elements to induce a user's key press at a corresponding location to a specific motion of the virtual character, and a dance game control unit controlling an image processor that processes the motion information and the rhythm notes and outputs the processed motion information and rhythm notes to a display interface, the method comprising steps of (a), (b), (c), and (d) performed in the dance game control unit:
(a) controlling the image processor to display the motion information, searching each frame of the motion information, and determining whether the character is in a predetermined specific motion state;
(b) controlling the image processor to display the rhythm note on predetermined coordinates according to a dance motion of the virtual character when the virtual character is in the predetermined specific motion state as a result of the determination;
(c) verifying whether a corresponding key to the rhythm note being displayed through the step of (b) is inputted; and
(d) counting a score indicating the user's game ability when the corresponding key is inputted as a result of the verification in the step of (c).

2. The method of claim 1, wherein the rhythm note being displayed through the step of (b) is a type of a moving picture which is sequentially transformed to disappear based on the predetermined coordinates.

3. The method of claim 2, wherein the rhythm note being displayed through the step of (b) explodes when disappeared.

4. The method of claim 3, wherein the motion information being displayed in the step of (a) is produced via a three-dimensional graphic tool, and the rhythm note being displayed through the step of (b) is based on three dimensional coordinates.

5. The method of claim 4, wherein the rhythm note being displayed through the step of (b) is a direction note which is displayed according to a moving direction of a specific portion of the virtual character, or a ring note encircling the virtual character.

6. The method of claim 5, wherein, when the rhythm note being displayed through the step of (b) is the direction note, the step of (c) verifies whether the corresponding key to the rhythm note is inputted at a predetermined key input point.

7. The method of claim 6, wherein, when the rhythm note being displayed through the step of (b) is the ring note, the step of (c) verifies whether the corresponding to the rhythm note is continuously inputted for a predetermined key press time.

8. The method of claim 7, further comprising:
(e) counting a point to upgrade motions of the virtual character when the corresponding key to the rhythm note is inputted as a result of the verification in the step of (c); and
(f) controlling the image processor to upgrade the dance motion of the virtual character and display the upgraded dance motion when there is a key input using the point.

9. The method of claim 8, wherein the step of (f) displays a previous motion with a present motion of the virtual character.

10. A computer-readable storage medium storing instructions for implementing the method of any one of claims 1 through 9.
